(19) United States
(12) Patent Application Publication
(10) Pub. No.: US 2010/0157448 A1
(43) Pub. Date: Jun. 24, 2010

(54) LENS HOLDER, CAMERA MODULE HAVING SAME, AND METHOD FOR MAKING SAME

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/547,680

(22) Filed: Aug. 26, 2009

(30) Foreign Application Priority Data
Dec. 18, 2008 (CN) 200810306350.5

(51) Int. Cl. G02B 7/02; B29C 45/00; B82B 1/00; B82B 3/00

(52) U.S. Cl. 359/819; 264/328.1; 977/742; 977/750; 977/752

(57) ABSTRACT

A lens holder is made of a composite material, and the composite material is capable of blocking outside electromagnetic radiation. The composite material includes CNTs, carbon black and polymer. The CNTs and the carbon black are dispersed in the polymer.

### BACKGROUND

1. Technical Field

The present disclosure relates to a lens holder for blocking outside electromagnetic radiation, a camera module having the lens holder, and a method for making the lens holder.

2. Description of Related Art

An image sensor is a key component of a camera module, and is typically retained in a lens holder of the camera module. Electromagnetic interference (EMI) originating from outside the camera module may affect the functionality of the image sensor. The EMI may deteriorate the quality of images picked up by the image sensor.

Generally, a copper or stainless steel film is applied on an outer surface of the lens holder to block external electromagnetic radiation from entering the lens holder. The blocking film is formed on the outer surface of the lens holder by a coating process. The coating process requires expensive coating apparatuses and vacuum systems. Hence, the cost of the lens holder is correspondingly high.

Therefore, a new lens holder, a new camera module, and a new method are desired to overcome the above-mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a cross-sectional view of a camera module according to an exemplary embodiment of the present disclosure.

FIG. 2 is a schematic, enlarged view of an area marked II of the camera module of FIG. 1.

### DETAILED DESCRIPTION

Embodiments will now be described in detail below with reference to the drawings.

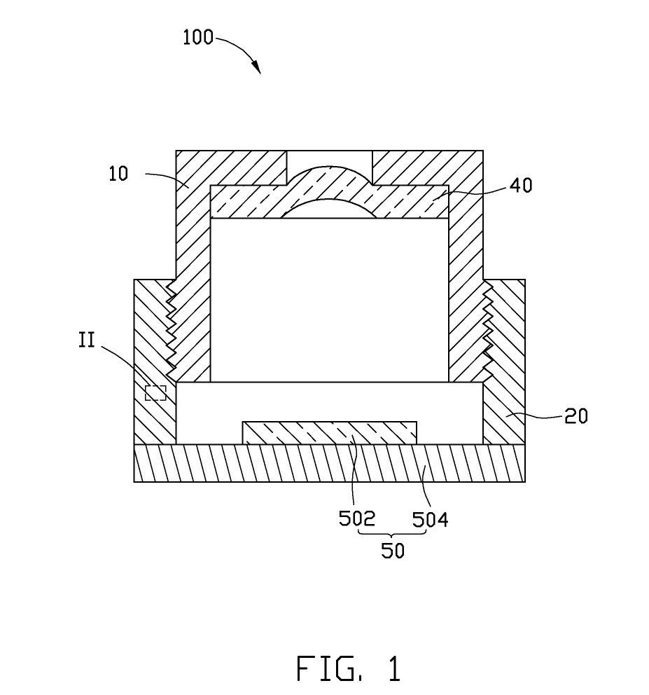

Referring to FIG. 1, a camera module 100 according to an exemplary embodiment is shown. The camera module 100 includes a barrel 10, a lens 40, a lens holder 20, an image sensing unit 50. The lens 40 is received in the barrel 10. The barrel 10 is threadedly coupled to and partly received in the lens holder 20. The image sensing unit 50 includes an image sensor 502 and a circuit board 504. The image sensor 502 is mechanically and electrically mounted on the circuit board 504. The image sensor 502 is received in the lens holder 20. The image sensor 502 can be a charge coupled device (CCD) or a complementary metal oxide semiconductor transistor (CMOS). The image sensor 502 is in optical alignment with the lens 40.

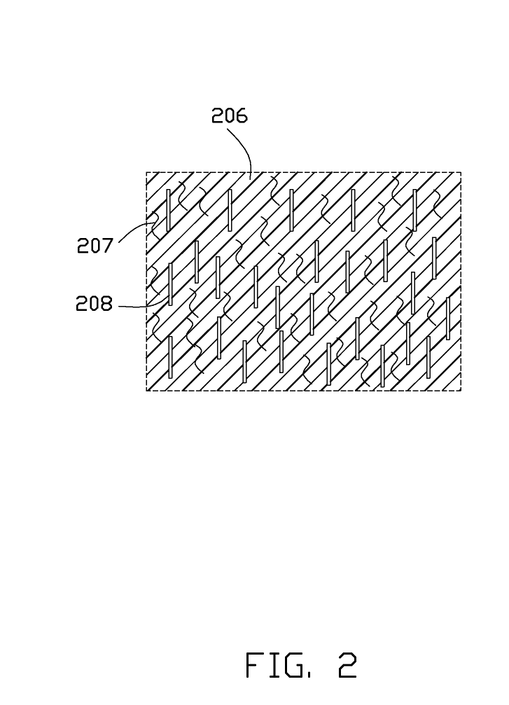

Also referring to FIG. 2, the lens holder 20 is comprised of a composite material capable of blocking electromagnetic radiation originating from outside the lens holder 20. In the present embodiment, the lens holder 20 is made of the composite material. The composite material includes a plurality of carbon nanotubes (CNTs) 208, carbon black 207, and a polymer 206. The CNTs 208 and the carbon black 207 are substantially uniformly dispersed in the polymer 206. In the illustrated embodiment, all the CNTs 208 are aligned substantially parallel to each other. In particular, all the CNTs 208 are aligned substantially parallel to an optical axis of the camera module 100. That is, all the CNTs 208 are aligned substantially parallel to a central axis of the lens holder 20. A weight ratio of the CNTs 208 in the composite material is in a range from 1% to 15%, and a weight ratio of the carbon black 207 in the composite material is in a range from 1% to 10%. The polymer can include a material selected from the group consisting of polycarbonate (PC), acrylonitrile butadiene styrene (ABS), glass fiber, polyphthalamide (PPA), polyphenylene oxide (PPO), and any combination thereof, such as PC/ABS, PC/glass fiber, etc. The CNTs 208 can be single-walled CNTs or multi-walled CNTs.

The lens holder 20 can be made using the method described below:

First, a mixture of the CNTs 208 and the carbon black 207 is prepared using arc discharge.

Second, a mixture of the CNTs 208 and the carbon black 207 together with the polymer 206 is heated and blended to obtain a composite material. The composite material is capable of blocking outside electromagnetic radiation, thus protecting the image sensor 502 from electromagnetic interference.

Third, the composite material is fed into an injection molding machine (not shown), and the lens holder 20 is formed by injection molding.

In summary, the lens holder 20 is made from a composite material capable of blocking outside electromagnetic radiation, thus protecting the image sensor 502 from electromagnetic interference. The lens holder 20 can be made by injection molding the composite material. Accordingly, unlike in conventional art, expensive apparatuses such as coating apparatuses and vacuum systems are not needed to produce the lens holder 20. As a result, the cost of the lens holder 20 is reduced.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

What is claimed is:

1. A lens holder comprised of a composite material, the composite material being capable of blocking outside electromagnetic radiation, the composite material being comprised of a plurality of carbon nanotubes (CNTs), carbon black and polymer, the CNTs and the carbon black being dispersed in the polymer.

2. The lens holder of claim 1, wherein the polymer is comprised of material selected from the group consisting of polycarbonate (PC), acrylonitrile butadiene styrene (ABS), glass fiber, polyphthalamide (PPA), polyphenylene oxide (PPO), and any combination thereof.

3. The lens holder of claim 2, wherein a weight ratio of the CNTs in the composite material is in a range from 1% to 15%.

4. The lens holder of claim 2, wherein a weight ratio of the carbon black in the composite material is in a range from 1% to 10%.

5. The lens holder of claim 1, wherein the CNTs and the carbon black are substantially uniformly dispersed in the polymer.

6. The lens holder of claim 5, wherein all the CNTs are aligned substantially parallel to each other.

7. The lens holder of claim 6, wherein all the CNTs are aligned substantially parallel to a central axis of the lens holder.

8. The lens holder of claim 1, wherein the lens holder is made of the composite material.

9. The lens holder of claim 1, wherein each CNT is single-walled or multi-walled.

10. A camera module comprising:
a lens;
a barrel accommodating the lens therein; and
a lens holder receiving at least part of the barrel therein, the lens holder comprised of a composite material, the composite material being capable of blocking outside electromagnetic radiation, the composite material being comprised of a plurality of CNTs, carbon black and polymer, the CNTs and the carbon black being dispersed in the polymer.

11. The camera module of claim 10, wherein the polymer is comprised of a material selected from the group consisting of polycarbonate (PC), acrylonitrile butadiene styrene (ABS), glass fiber, polyphthalamide (PPA), polyphenylene oxide (PPO), and any combination thereof.

12. The camera module of claim 11, wherein a weight ratio of the CNTs in the composite material is in a range from 1% to 15%.

13. The camera module of claim 11, wherein a weight ratio of the carbon black in the composite material is in a range from 1% to 10%.

14. The camera module of claim 10, wherein each CNT is single-walled or multi-walled.

15. A method for making a lens holder, the method comprising:
heating a plurality of CNTs, an amount of carbon black and an amount of polymer together, and blending the polymer, the CNTs and the carbon black, thus obtaining a composite material capable of blocking outside electromagnetic interference; and
forming a lens holder by injection molding the composite material.

16. The method of claim 15, further comprising forming the CNTs and the carbon black by arc discharge.

17. The method of claim 15, wherein the polymer is comprised of material selected from the group consisting of polycarbonate (PC), acrylonitrile butadiene styrene (ABS), glass fiber, polyphthalamide (PPA), polyphenylene oxide (PPO), and any combination thereof.

18. The method of claim 16, wherein a weight ratio of the CNTs in the composite material is in a range from 1% to 15%.

19. The method of claim 16, wherein a weight ratio of the carbon black in the composite material is in a range from 1% to 10%.

20. The method of claim 15, wherein each CNT is single-walled or multi-walled.
